(19) United States
(12) Patent Application Publication
(10) Pub. No.: US 2007/0292023 A1
(43) Pub. Date: Dec. 20, 2007

(54) Data reduction for wireless communication

(76) Inventors: Richard L. Baer, Los Altos, CA (US); Aman Kansal, Redmond, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/471,744

(22) Filed: Jun. 20, 2006

(51) Int. Cl. G06K 9/34

(52) U.S. Cl. 382/173

(57) ABSTRACT

A method including capturing an image, segmenting the image into foreground and background pixels, coalescing contiguous foreground pixels into a blob, associating a weight for each pixel in the blob, and determining a position in the image for the blob.

### BACKGROUND

Prior art image compression methods have been developed based on frequency domain transforms, run-length encoding, and model-based representations. Many are based on standards such as JPEG, TIFF, and GIF. These methods compress an image such that the image information is either retained in its entirety or some components of the image data are discarded which do not significantly impact the perceptual quality of an image. These methods reduce the number of bits needed for storing and communication image. They work well for human vision evaluation.

Unfortunately, the number of bits required for transmission is large and unwieldy for wireless communication from a battery operated device. The battery cost of communication depletes batteries faster than is desirable for many applications. In addition, the compression methods are designed for retaining the perceptual quality of the image with respect to the human vision system and not for preserving the image information of relevance to automatic image processing for machine intelligence.

### SUMMARY

A method reducing the number of bits required for representing the information in an image. The number of bits directly affects the communication costs of data transmission in terms of energy consumption and bandwidth required in a wireless network. The method includes capturing an image, segmenting the image into foreground and background pixels, coalescing contiguous foreground pixels into a blob, associating a weight for each pixel in the blob, and determining a position in the image for the blob.

### BRIEF DESCRIPTION OF THE DRAWINGS

FIG. 1 illustrates an embodiment of the invention.

### DETAILED DESCRIPTION

The image detection technique is geared towards wireless and low power devices that are not expected to execute at speeds over 100 kBaud.

The data reduction method is designed for machine vision tasks such as automated motion detection, e.g. automatically opening doors, controlling lights, and detecting intrusion.

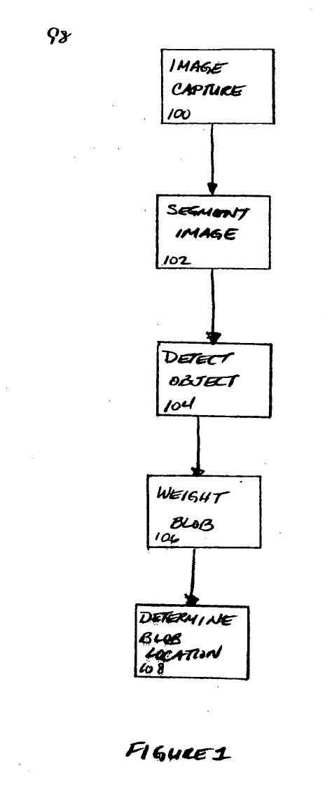

As shown in FIG. 1, in step 100, the image is captured. In step 102, Image Segmentation, the image is segmented into two conceptual constituents: background and foreground. The background is the environment imaged in the scene. The foreground is defined to be the set of significant objects in the scene that need to be detected and characterized. Many different kind of segmentation can be performed. One of the simplest is segmentation by motion. Pixels that change from scene to scene are included in the foreground, while those that do not are included in the background.

The foreground regions from image segmentation are input for object detection and characterization.

In step 104, Detection, the contiguous pixels of the foreground regions are coalesced. Each coalesced region is referred to as a “blob”.

In step 106, for each blob, a “weight” is determined that indicates the number of pixels in that blob and the difference values at those pixels. Each blob corresponds to either a significant object that appeared in the scene and is not part of the background or to small movements in the background objects themselves. The weight distinguishes between the two types of blobs.

In step 108, for each blob, the object characterization features are determined according to the size of the blob, and luminance of the object in the scene. One additional consideration may be texture of the object. This data may be used in machine vision algorithms for object classification tasks so that appropriate actions may be performed based on the location and object type detected. Regions of the image corresponding to each blob provide a photograph of the detected object. These regions are a subset of the image data. When applied in machine vision tasks, the subset may be included in the reduced data.

The process may be adapted to include data about the direction and movement of the detected object in the imaged scenes. Two sequential images are captured and analyzed as described above. After individual characterization, the images may be correlated to one another. Thus, for each blob of the first image, the blob of the second image that is closest to it in this multi-dimensional space of object characterization features are considered to emanate from the same physical object in the imaged scene. For each pair of correlated blobs, a spatial vector is computed between the locations of the blobs in the first and the second images. This vector indicates the direction and speed of motion of the detected object and is represented by two numbers.

The object characterization features and the velocity vectors of each blob form a set of numbers that correspond to it. These numbers form a blob vector. One component of the blob vector is the weight metric computed during detection. The blob vectors are arranged in order of decreasing weight. The reduced data set consists of a set of numbers characterizing the objects in the scene and these numbers are arranged in decreasing order of their significance. The number of bits required to store these numbers is significantly smaller (at least two orders of magnitude) than the number of bits required to represent the entire image.

Although the present invention has been described in detail with reference to particular embodiments, persons possessing ordinary skill in the art to which this invention pertains will appreciate that various modifications and enhancements may be made without departing from the spirit and scope of the claims that follow.

We claim:

1. A method comprising:
capturing an image;
segmenting the image into foreground and background pixels;
coalescing contiguous foreground pixels into a blob;
associating a weight for each pixel in the blob; and
determining a position in the image for the blob.

2. A method, as in claim 1, associating including:
determining the number of pixels in the blob; and
determining the difference values at each pixel in the blob.

3. A method, as in claim 1, determining a position including finding object characterization features based on a scene parameter.

4. A method, as in claim 3, wherein the scene parameter is selected from a group consisting of size of blob, luminance, and texture.

5. A method comprising:
capturing a first and a second image;
for each image, segmenting the image into foreground and background pixels;
for each image, coalescing contiguous foreground pixels into a blob;
for each image, associating a weight for each pixel in the blob;
for each image, determining a position in the image for each blob; and
correlating the blobs in the first and second image by a scene parameter.

6. A method, as in claim 5, wherein the scene parameter is selected from a group consisting of luminance, and weight.
